(19) United States
(12) Patent Application Publication
(10) Pub. No.: US 2015/0302957 A1
(43) Pub. Date: Oct. 22, 2015

(54) METHOD OF LASER TRIMMING AT LOW AND HIGH TEMPERATURES

(71) Applicant: Ohmite Manufacturing Co., Arlington Heights, IL (US)

(72) Inventors: Michael R. West, Harlingen, TX (US); Kevin M. Kreger, Merrimack, NH (US)

(73) Assignee: Ohmite Manufacturing Co., Arlington Heights, IL (US)

(21) Appl. No.: 14/679,484

(22) Filed: Apr. 6, 2015

Related U.S. Application Data
(60) Provisional application No. 61/981,351, filed on Apr. 18, 2014.

(51) Int. Cl. H01C 17/242; B23K 26/30; B23K 26/00

(52) U.S. Cl. CPC H01C 17/242; B23K 26/0003; B23K 26/422; B23K 26/421; B23K 26/423

(57) ABSTRACT

A method for high and low temperature laser trimming of resistors is provided. The method includes a ceramic heating plate for heating resistors to a designated temperature before trimming the resistors.

### CROSS-REFERENCE TO RELATED APPLICATIONS

This application claims priority from U.S. Provisional Application No. 61/981,351, filed on Apr. 18, 2014, the entirety of which is hereby fully incorporated by reference herein.

### TECHNICAL FIELD

This disclosure relates to the trimming of circuit components. The disclosure relates most directly to the trimming of resistors such as thin film resistors, thick film resistors, and thermistors at hot and cold temperatures. Specifically, this disclosure relates to heating resistors to high temperatures and laser trimming the resistors at high temperatures.

### BACKGROUND OF THE INVENTION

The trimming of resistors and other electronic components is a procedure used in the manufacture of microelectronics and electronic components. Typically, an electronic component, either individually or within a circuit, is trimmed so that the component or circuit as a whole will perform in line with certain target parameters

One method of trimming is laser trimming. As an example, in the laser trimming process, a resistor may be connected to a measurement system and the resistance value measured. A laser then micro machines a trim path in the resistor material.

One commonly encountered problem with laser trimming is resistors rarely have a temperature coefficient of resistance (TCR) of zero. Resistors with a positive or negative TCR will exhibit different resistance at high and low temperatures. Additionally, circuits often utilize thermistors, resistors designed to vary resistance with temperature. If the resistance increases with increasing temperature the device is called a positive temperature coefficient (PTC) thermistor. If the resistance decreases with increasing temperature the device is called a negative temperature coefficient (NTC) thermistor. PTC and NTC thermistors are designed to have certain resistances at certain temperatures but thermistor performance often does not equal the designed performance. Resistors and other circuit components not performing as designed often have negative consequences in the performance of the overall circuit.

### BRIEF SUMMARY

A first representative embodiment of the disclosure is provided. The first embodiment discloses a laser trimming system and a method for trimming resistors or other circuit components at high or low temperatures. The method includes laser trimming a circuit component to a target value after the component and component substrate have been heated or cooled by a heating plate or a cold plate and have reached a target temperature for trimming.

Other embodiments of the disclosure will become apparent in view of the following description taken in connection with the accompanying drawings.

### BRIEF DESCRIPTION OF THE DRAWINGS

FIG. 1 is a block diagram of a laser trimming system.

FIG. 2 is a block diagram of the laser trimming program that controls the automated functions of the laser trimming system.

FIG. 3 shows an embodiment of a heating plate and a conveyor portion used in a laser trimming system.

FIG. 4 shows an embodiment of a parameter tester used in a laser trimming system.

FIG. 5 shows and embodiment of a laser trimming chamber used in a laser trimming system.

### DETAILED DESCRIPTION OF THE DRAWINGS AND THE PRESENTLY PREFERRED EMBODIMENTS

Embodiments of the present invention provide systems and methods for laser trimming of individual components or components on circuit substrate layers. Descriptions of specific applications are provided only as examples. Various modifications, substitutions and variations of the preferred embodiment will be readily apparent to those skilled in the art, and the generic principles defined herein may be applied to other embodiments and applications without departing from the scope of the claimed invention.

Embodiments are described with reference to the drawings in which like elements are generally referred to by like numerals. The relationship and functions of the various elements of the embodiments may better be understood by reference to the following detailed description. However, embodiments are not limited to those illustrated in the drawings. It should be understood that the drawings are not necessarily to scale, and in certain instances details may have been omitted that are no necessary for an understanding of the embodiments.

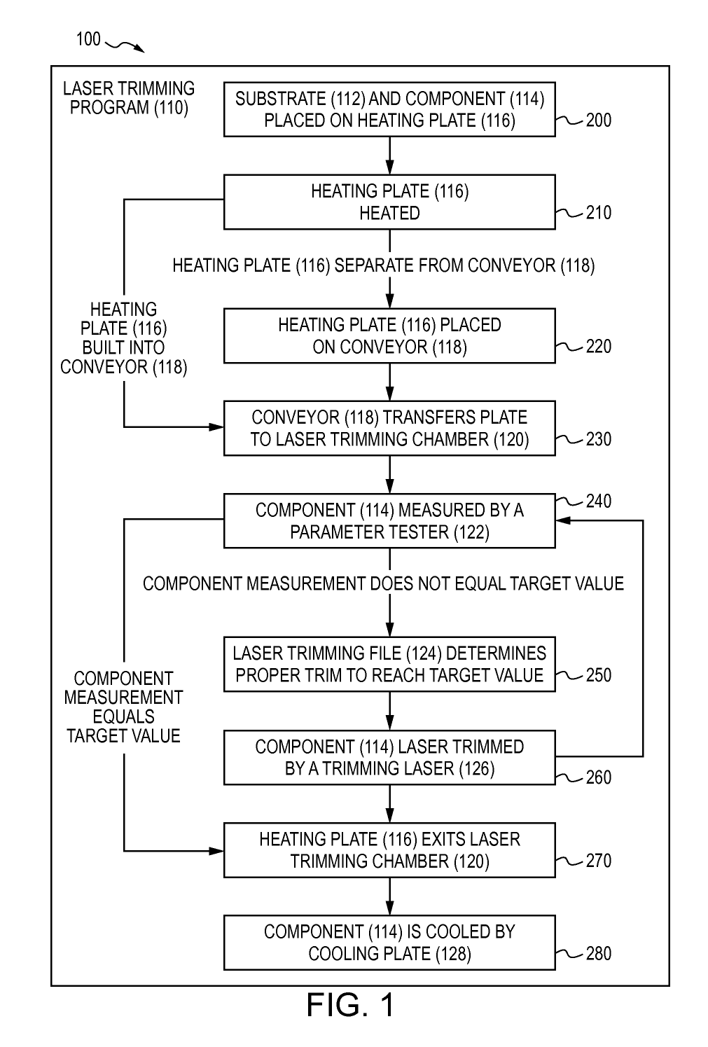

Referring to FIG. 1, a block diagram of a system in which the present invention may be practiced is illustrated generally 100. The representative system 100 includes a laser trimming program 110, a substrate 112, one or more components 114, a heating plate 116, a conveyor 118, a laser trimming chamber 120, a parameter tester 122, a laser trimming file 124, a trimming laser 126, and a cooling plate 128.

A substrate 112 has a circuit 130 or components 114 disposed upon the substrate in a manner to obtain desired electrical performance. The substrate 112 and components 114 are placed on the heating plate 116. The heating plate 116 may be built into the conveyor 118 or may be placed on the conveyor 118. The laser trimming program 110 controls (either directly or indirectly) the movement of the conveyor 118, which moves the heating plate 116 into and out of the laser trimming chamber 120. The trimming laser 126 may be contained within the laser trimming chamber 120. A laser trimming file 124 may control the movement of the trimming laser 126 in order to trim the component 114 material (such as the resistive material of a resistor) from the substrate 112 as desired. In other embodiments, the trimming laser 126 may be controlled manually in order to trim component 114 material from the substrate 112. The parameter tester 122 (such as a resistance measurement device) sends a testing output to the laser trimming file 124 and the laser trimming program 110. The cooling plate 128 may be attached to the bottom of the heating plate 118. The laser trimming program 110 controls the components of the system and the movement of the substrate 112 through the system.

In operation, circuit components 114, printed circuit boards 130, or other structures with substrate layers of fabricated components are placed on the heating plate 116, as in step 200. The heating plate 116 is heated until the plate reaches a target temperature, as in step 210. The heating plate 116 transfers heat to the component or circuit substrate 112. When the components 114 or circuits 130 reach the target temperature (as monitored directly or indirectly by monitoring the temperature of the heating plate 116 and/or the substrate, or another indirect measurement of the components or circuits), the laser trimming program 110 activates the conveyor 118 and the conveyor 118 moves the heating plate 116 into the laser trimming chamber 120, as in step 230. The parameter tester 122 tests the components 114 while at the elevated temperature, as in step 240. The parameter tester 122 outputs a file that provides the location (x, y coordinates) of each component 114 and the associated parameter value. The laser trimming file 124 then uses the output of the parameter tester 122 to calculate the proper trim path, as in step 250. The trimming laser 126 trims the components 114 by micro machining a trim path, as in step 260. While undergoing trimming, the parameter tester 122 tests the designated parameter of the components 114 or circuit boards 130, while at the elevated temperature. The parameter tester 122 provides feedback to the laser trimming file 124. When the target value (resistance or other tested parameter) is reached the trimming laser 126 is automatically stopped and the trim path ends. The laser trimming chamber 120 opens. The conveyor 118 and heating plate 116, which may be built into the conveyor or removable, are moved from the laser trimming chamber 120 by the laser trimming program 110, as in step 270. The heating plate 116 is cooled by a cooling plate 128 to approximately room temperature and the trimming method is complete, as in step 280.

In one embodiment of the invention, the laser trimming system 100 may be used to trim a variety of components 114, such as thin-film resistors, thick-film resistors, or thermistors. In this embodiment, fabricated resistor substrates are placed on the heating plate 116. A target resistance may be entered into the laser trimming program 110 and the parameter tester 122 tests resistances. Many of the embodiments described hereinafter will describe the laser trimming system 100 in the context of laser trimming of resistors. Those skilled in the art will realize the laser trimming system 100 is capable of both passive trimming and active trimming.

In embodiments undertaking passive trimming, the laser trimming system 100 will engage in trimming of discrete circuit components. In one embodiment the laser trimming system 100 trims resistors while the parameter tester 122 is programed to test for a target resistance. In another passive trimming embodiment capacitors are trimmed with the parameter tester 122 programmed to test for target capacitance. Those skilled in the art will realize the laser trimming system may be used in passive trimming of other discrete circuit components.

In embodiments engaged in active trimming, a circuit 130 substrate 112 may be placed on the heating plate 116 and a circuit 130 parameter, such as voltage, current, frequency, power, phase, or other measurable circuit parameters, may be entered into the laser trimming program 110. The parameter tester 122 measures the circuit 130 parameter designated by the user in the laser trimming program 110, while the substrate 112 and circuit 130 are at an elevated temperature, and compares the measured value to the target value. The trimming laser 126 is used to trim a circuit component, often a resistor or capacitor, until the circuit as a whole reaches the target value.

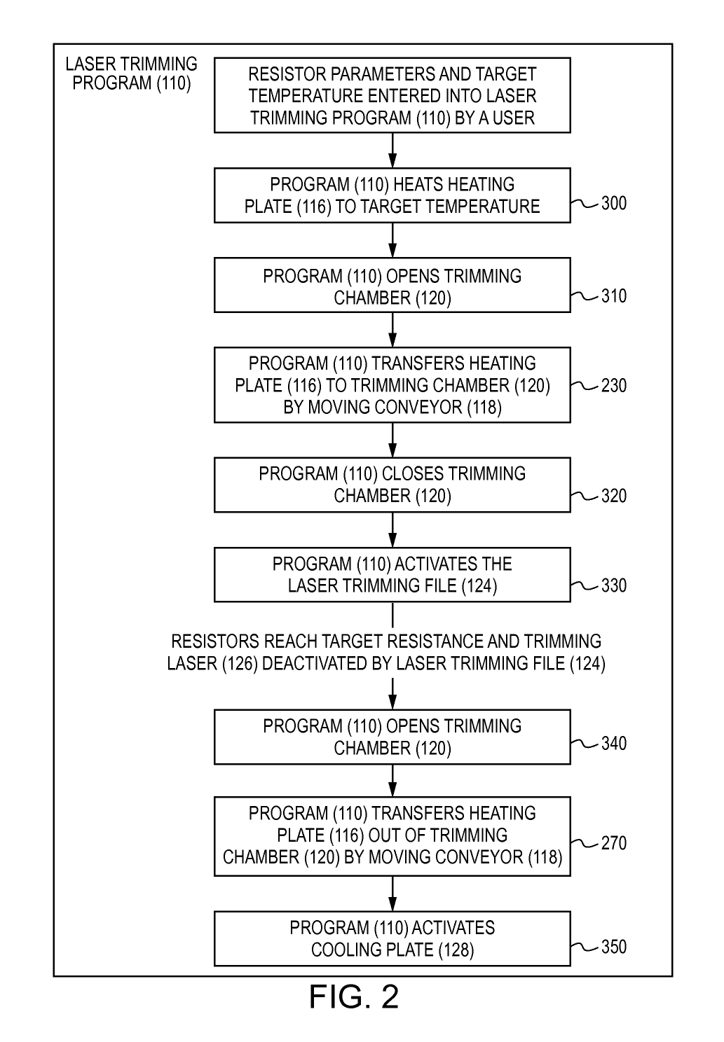

Referring to FIG. 2, a block diagram of an embodiment of the laser trimming program 110 is illustrated generally. The embodiment demonstrates the components of the system controlled by the laser trimming program 110. The embodiment illustrates the laser trimming system used to trim thermistors or resistors. A user enters the system constraints into the laser trimming program 110. These constraints may include the resistor characteristics, the target resistance, the target trimming temperature, heating time, trimming parameters, and cooling time. The system may be configured to use other relevant constraints.

In the embodiment shown in FIG. 2, the laser trimming program 110 heats the heating plate 116 to the user inputted trimming temperature, as in step 300. After the heating plate 116 reaches the target trimming temperature and the program 110 opens the trimming chamber, as in step 310, the laser trimming program moves the conveyor 118 until the heating plate 116 is within the trimming chamber 120, as in step 230. The laser trimming program 110 closes the heating chamber 120 and activates the laser trimming file 124, as in steps 320 and 330. After the laser trimming is complete, the laser trimming program 110 opens the laser trimming chamber 120 and moves the conveyor 118 until the heating plate 116 is outside of the laser trimming chamber 120, as in steps 340 and 270. The laser trimming program 110 activates the cooling plate 128, as in step 350.

Embodiments of the invention can be practiced without the use of a laser trimming program. In some embodiments the components controlled by the laser trimming program can be operated manually. In other embodiments a laser trimming program can control some parameters while others can be manipulated manually.

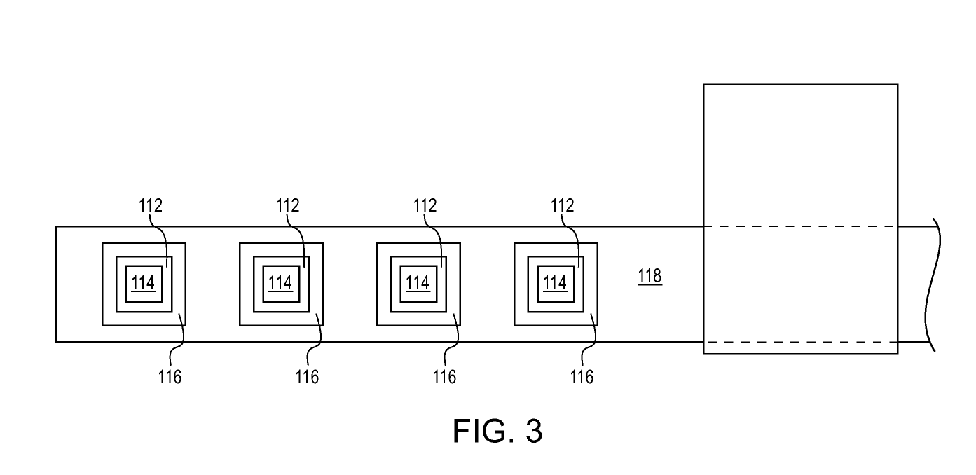

FIG. 3 shows a heating plate 116 and a substrate 112 with resistors 114 placed on the plate. The heating plate 116 may be contained directly within the conveyor 118. The heating plate 116 and conveyor 118 are shown during the heating process of the disclosed method. Other embodiments of the present invention may have the heating plates 116 separate from the conveyor 118. These embodiments allow for the heating plate 116 to be placed on a conveyor 118, as in step 220 of FIG. 1, or do not use a conveyor 118. In embodiments that do not use a conveyor 118 the heating plates 116 are heated to the trimming temperature and then manually placed in a laser trimming area.

Substrate 112 with resistors or other components 114 may be placed on a heating plate 116 that may be approximately ambient temperature (the heating plate 116 may also be a temperature hotter or colder than ambient temperature). In one embodiment, the heating plate 116 may gradually increases its internal temperature until it reaches the target temperature. In an exemplary embodiment the heating plate 116 may not be heated uniformly. Those familiar with the art will know that heating the heating plate 116 equally may cause higher temperatures towards the center of the heating plate 116 due to heat dissipation at the edges of the plate 116. To ensure the heating plate 116 is a uniform temperature throughout the plate surface, an exemplary embodiment will heat the heating plate 116 to relatively higher temperatures near the outside of the plate and to relatively cooler temperatures near the middle of the plate. In some embodiments the heating plate 116 may be ceramic but the heating plate 116 may be made of other materials known in the art that can withstand extreme temperatures and effectively transfer heat to the substrate 112. To prevent cracking of the heating plate 116 the plate may be heated at a ramp rate. In embodiments employing a laser trimming program 110 the ramp rate may be automatically calculated and controlled by the laser trimming program 110. In some embodiments the heating plate 116 may be heated electronically. Those skilled in the art will know that the plate could be heated using other techniques such as gas or fluid heating.

Some embodiments may use a temperature sensor to test the substrate 112 and component 114 temperatures before moving the heating plate 116, substrate 112, and components 114 into the laser trimming chamber 120. A temperature sensor may be employed to test the temperature of the substrate 112, components 114, or both the substrate 112 and components 114. Embodiments of the laser trimming system 100 may employ a traditional thermometer, an infrared sensor, a fiber optic temperature sensor, a thermocouple, a temperature strip, or other temperature sensors capable of measuring the temperature of the substrate 112 or components 114.

Some embodiments may be designed for precise heat transfer from the heating plate 116 to the substrate 112 and components 114. These embodiments may rely on a temperature sensor disposed in the heating plate 116. Still further embodiments may not employ a temperature sensor and rely on the laser trimming program 110 to accurately control heating of the heating plate 116 and the subsequent transfer of heat to the substrate 112 and components 114 to the user designated target trimming temperature.

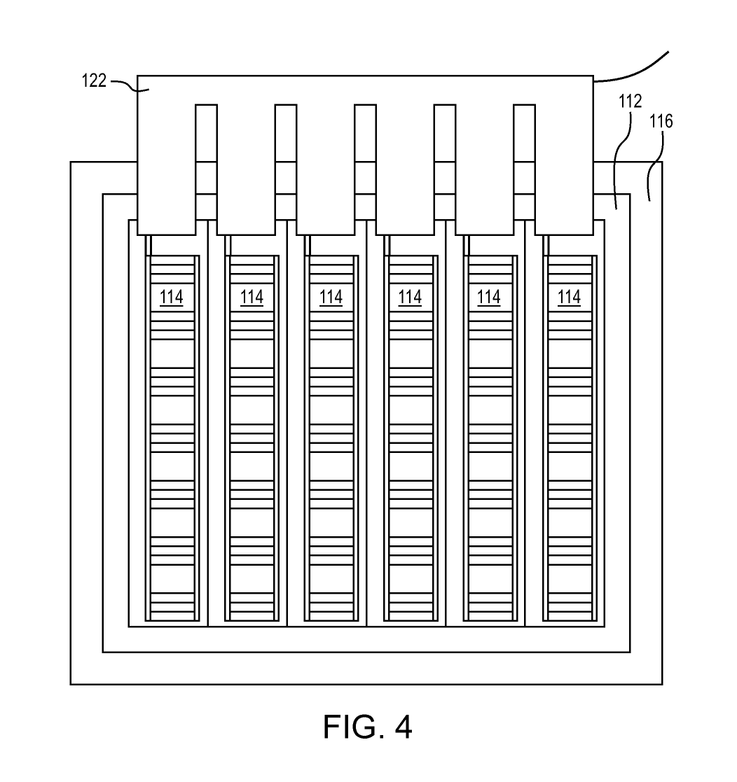

FIG. 4 shows an embodiment of a parameter tester 122. In some embodiments, the parameter tester 122 may continuously measure the component's 114 designated parameter. FIG. 4 shows an embodiment of the parameter tester 118 measuring resistance of thin-film resistors. The measured parameter compared to the target parameter set by the user in the laser trimming program 110. When the measured parameter is equal to the target parameter the parameter tester 122 signals the laser trimming file 124 to shut down the trimming laser 126 and the trim path cut is stopped. In some embodiments the parameter tester 122 may not measure the designated parameter continuously. In these embodiments the trimming of the components 114 may be done with a step and repeat method. In embodiments of the present invention engaged in active trimming the parameter tester 122 may test for a circuit parameter designated by the user in the laser trimming program 110.

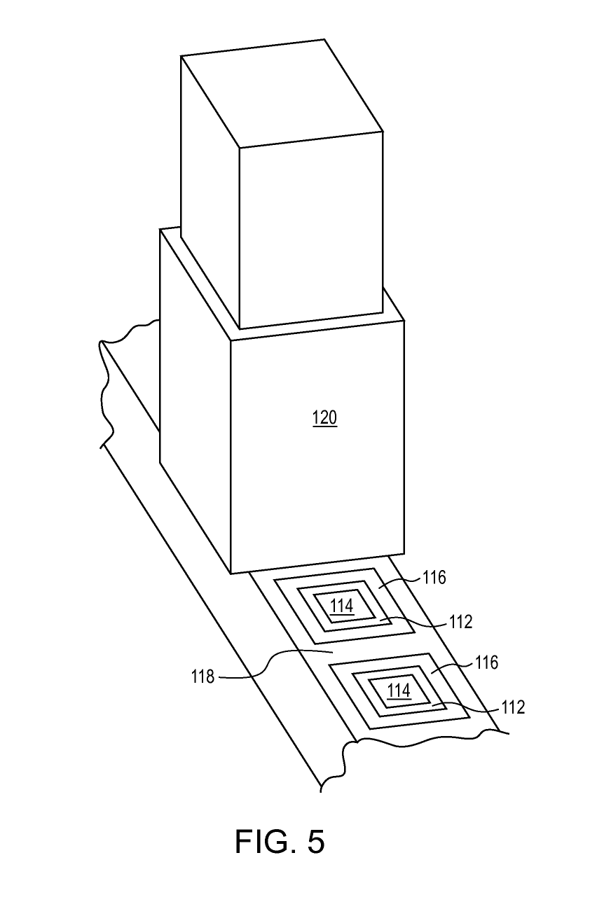

FIG. 5 shows the laser trimming chamber 120. The laser trimming chamber 120 contains the parameter tester 122 and the trimming laser 126.

According to one embodiment, once the substrate 112 and component 114 reach the target temperature and enter the laser trimming chamber 120, a laser trimming file 124 may control the trimming laser 126 to form a planar trim channel in the circuit component 114. The trim channel removes component material from the substrate and alters the component performance. The laser trimming file 124 can calculate a trim path using the output of the parameter tester 122 and the parameter target value from the laser trimming program 110. An exemplary laser trimming file 124 may include factors such as laser beam spot size, pulse duration, aperture, energy, angle, step size, and overlap factor. Those skilled in the art will realize a laser trimming file may be capable of receiving and controlling additional factors. A user may also input a desired laser trim type into laser trimming program 110. The laser trimming file 124 controls the trimming laser 126 to create a path following the designated trim type. Trim types may include plunge, double plunge, L-cut, scan, serpentine, or other trim path and types known within the industry. In some embodiments the laser trimming file 124 may be combined with the laser trimming program 110 to create a single piece of software that controls the entire laser trimming system 100. In other embodiments there may be no laser trimming file 124 and the operation of the trimming laser 126 is completed manually.

In one embodiment the parameter tester 122 may be designed to sense, calculate, and output X and Y coordinates of the components 114 to be trimmed. The laser trimming file 124 or manual operator may use the X and Y coordinates to calculate the desired trim path. In other embodiments a separate X-Y sensor may be contained in the laser trimming chamber 120. A separate X-Y sensor would function similarly to a sensor coupled to the parameter tester 122. Other embodiments do not necessitate an X-Y sensor. In these embodiments, the system may be designed to trim circuit components 114 or circuits of a designated dimension. This designated dimension may be contained in the laser trimming program 110 or may be adjustable by a user. In these embodiments, the heating plate 116 may be designed to hold components 114 of the designated dimension and the laser trimming file 124 may use trim factors and trim paths designed to operate on components 114 of the designated dimension. These embodiments may be designed to increase the throughput of the laser trimming system 100.

Industry standard laser trimming systems typically operate with a laser trim window of five inches. In an exemplary embodiment, the laser trimming system 100 may be designed to operate with a laser trimming window of eight inches. In one embodiment, a laser trimming window of eight inches allows for a heating plate 116 to hold fifteen resistors. The trim time for fifteen resistors may be approximately twenty-five seconds. Those skilled in the art will realize this embodiment is described as way of an example and other component 114 capacities and trim times may be employed by other embodiments. Those skilled in the art will realize the system can be scaled up to accommodate increased trimming capacity. Those skilled in the art will also realize the system can be scaled down for operations that do not require high capacity output.

Those skilled in the art will realize the laser trimming chamber 120 is not a required component of the disclosed laser trimming system 100. In embodiments employing a laser trimming chamber 120, the laser trimming chamber 120 may be designed to prevent air currents over the substrate 112, and circuits or circuit components 114. Air currents can change the temperature of the substrate 112 and circuits or circuit components 114. Any change in temperature can adversely affect the accuracy of the trim path and thereby alter the trimmed components 114 performance at the target temperature. The laser trimming chamber 120 may be designed to protect users from exposure to the trimming laser 126 which can severely damage eyesight. Those skilled in the art will realize that other techniques can be used to prevent air currents and user exposure to a laser.

Referring to FIG. 5, an embodiment of the laser trimming system 100 demonstrating trimmed resistors leaving the laser trimming chamber 120 is shown. When the parameter tested value matches the target value the laser trimming program 110 activates the conveyor 118 and moves the heating plate 116, substrate 112, and trimmed resistors 114 out of the laser trimming chamber 120. In embodiments using a cooling plate 128, the laser trimming program 110 activates the cooling plate 128. The cooling plate 128 may work in a reverse manner of the heating plate 116. The cooling plate 128 may have a ramp rate of cooling designed to cool the heating plate 116 to ambient temperature. The ramp rate may be designed to cool the heating plate 116 quickly while also preventing cracking or damage to the heating plate 116, substrate 112, or components 114. In some embodiments the cooling plate 128 may be attached to the heating plate 116 throughout the entire laser trimming system 110. In other embodiments cooling plates 128 may be built beneath the portion of the conveyor 118 after the laser trimming chamber 120. Some embodiments may employ a dual heating and cooling plate that may be capable of being heated prior to trimming and cooled after trimming. Those skilled in the art will realize a cooling plate 128 is not a required component of the laser trimming system 110. In some embodiments the substrate 112, trimmed components 114, and heating plate 116 are allowed to sit in ambient temperature and return to ambient temperature at a natural cooling rate.

Those skilled in the art will realize the laser trimming system 110 and method can be adapted to perform laser trimming at cold temperatures. In cold trimming embodiments, the laser trimming system may be modified to use a cooling plate 128 to cool substrates 112 and components or circuits 114 to a target temperature. The components 114 are trimmed at this cooler target temperature and a heating plate 116 may be used after trimming to bring the substrate 112 and components or circuits 114 to ambient temperature. A laser trimming system 110 designed to trim at cold temperature may operate in substantially the same way as a system designed to trim at high temperatures.

While the preferred embodiments have been described and illustrated in detail, it is to be understood that this is intended by way of illustration and example only, the scope of the invention being limited by the terms of the following claims.

1. A method of trimming circuit components comprising:
disposing a component upon a substrate;
placing the substrate on a plate;
heating the plate to an elevated temperature above ambient temperature, thereby transferring heat to the substrate and the component from the plate, thereby heating the component to a second temperature above the ambient temperature; and,
trimming the component at the elevated temperature.

2. The method of claim 1, wherein the substrate is heated to a third temperature above the ambient temperature.

3. The method of claim 2, wherein the third temperature is greater than the second temperature.

4. The method of claim 1, further comprising entering a target component parameter into a control program;
testing the component parameter after heating, while the component is at the second temperature; and, comparing the tested parameter to the target parameter.

5. The method of claim 4, further comprising trimming the component at the second temperature until the tested parameter equals the target parameter.

6. The method of claim 5, further comprising cooling the plate to the ambient temperature after trimming.

7. The method of claim 6, further comprising moving the plate from a heating area to a trimming area; and, moving the plate from the trimming area to a cooling area.

8. The method of claim 7, wherein the heating, testing, trimming, comparing, and moving steps are controlled by the control program.

9. The method of claim 8, wherein the moving step is accomplished by a conveyor.

10. The method of claim 7, wherein the trimming area is a trimming chamber.

11. The method of claim 1, wherein the trimming step is accomplished by using a trimming laser.

12. The method of claim 1, wherein the elevated temperature is approximately 180 degrees Celsius.

13. The method of claim 1, wherein the component is a resistor.

14. The method of claim 1, wherein the component is a thermistor.

15. A method of trimming circuit components comprising:
disposing a component upon a substrate;
placing the substrate on a plate;
cooling the plate to a first temperature less than an ambient temperature, thereby the plate cooling the component to a second temperature less than the ambient temperature due to heat transfer from the substrate and component to the plate; and,
trimming the component at the second temperature.

16. A method of laser trimming resistors comprising:
placing a substrate with a resistor on a plate, and transferring the plate into a heating area;
heating the plate to a first temperature, the plate thereby transferring heat to the substrate and the resistor, thereby causing the resistor to heat to a second temperature above an ambient temperature;
testing the resistance of the resistor at the second temperature; and,
laser trimming the resistor while measuring the resistance at the second temperature until the resistor reaches a designated resistance.

17. A method of laser trimming resistors comprising:
placing a substrate with a resistor on a plate, and transferring the plate into a cooling area;
cooling the plate to a first temperature below an ambient temperature, heat thereby transferring to the plate from the substrate and the resistor until the resistor reaches a second temperature lower than the ambient temperature;
testing the resistance of the resistor at the second temperature; and,
laser trimming the resistor while measuring the resistance at the second temperature until the resistor reaches a designated resistance.
